(19) United States
(12) Patent Application Publication
(10) Pub. No.: US 2026/0209606 A1
(43) Pub. Date: Jul. 23, 2026

(54) PROCESS FOR PRODUCING RENEWABLE HYDROCARBONS FROM RENEWABLE FEEDSTOCK COMPRISING PHOSPHORUS AS IMPURITY

(71) Applicant: Neste Oyj, Espoo (FI)

(72) Inventors: Hemanathan Kumar, Porvoo (FI); Satu Vatanen, Porvoo (FI); Ronny WAHLSTRÖM, Porvoo (FI); Chunfen Jin, Porvoo (FI)

(73) Assignee: Neste Oyj, Espoo (FI)

(21) Appl. No.: 19/141,151

(22) PCT Filed: Dec. 18, 2023
(86) PCT No.: PCT/FI2023/050707

§ 371 Date: Jun. 19, 2025

(30) Foreign Application Priority Data
Dec. 21, 2022 (FI) 20226139

(51) Int. Cl. C10G 3/00; G01N 30/88

(52) U.S. Cl. CPC C10G 3/50; G01N 30/88; C10G 2300/1007; C10G 2300/1018; C10G 2300/201; C10G 2300/70; C10G 2400/02; C10G 2400/04; C10G 2400/08; G01N 2030/8872

(57) ABSTRACT

Process for producing renewable hydrocarbons suitable for use in fuel applications from a renewable feedstock. The feedstock includes at least one lipophilic phosphorus compound, which is difficult to remove therefrom by known purification methods. The amount of this “difficult to remove” phosphorus is determined and the result thereof is used for selecting a suitable purification to which the feedstock is then subjected. The purified renewable feedstock can then be hydrotreated catalytically.

### TECHNICAL FIELD

The present disclosure generally relates to production of hydrocarbon compositions. The disclosure relates particularly, though not exclusively, to production of hydrocarbon compositions from low quality i.e. impure or dirty feedstocks through catalytic conversion. Further, the present disclosure relates to analytic methods supporting the selection of pretreatments to be used on the feedstock before said catalytic conversion.

### BACKGROUND

This section illustrates useful background information without admission of any technique described herein being representative of the state of the art.

Treating vegetable oils for phosphorus removal is routine procedure, and currently there are various methods that can be employed to bleach and degum vegetable oils, explicitly water, acid, enzymatic, and membrane degumming techniques. Standard analyses for determination of total phosphorus content in a sample, such as an oil or fat sample, are routinely used procedures and widely available. However, these simple and low cost methods developed for edible oils are not informative enough analyses of low quality oils and fats used for fuel production, because they cannot discriminate between different P impurity types that may be found in the low quality feed pool.

In renewable feedstocks, phosphorus is a key impurity and catalyst deactivator that needs to be removed as efficiently as possible to support a long lifetime for a hydrotreatment catalyst. The presence of phosphorus in feed may lead to catalyst deactivation and reactor plugging in hydrotreatment due to formation and precipitation of phosphorus containing compounds, such as salts. Prior art phosphorus removal is discussed for example in US2013116491 A1, US2013116490 A1, EP3666866 A1 and US2011138680. As the lipid feed pool for hydrocarbon production has been increasingly extended to lower quality wastes and residues, phosphorus may appear in a form which is not affected by commonly applied purification processes, hence the so called “difficult to remove phosphorus”, has been encountered in an increasing number of feeds and quantities.

The hydratability of phospholipids is a well-known characteristic for the phospholipid compounds in the field of fats and oils chemistry. The division of phospholipids into hydratable and non-hydratable phospholipids has practical importance for understanding how well a fat or oil can be purified in water degumming. There is some ambiguity in the division as adjusting the pH in the degumming alters the division into hydratable and non-hydratable phospholipids. The non-hydratable phospholipids may be considered as a part of lipophilic phosphorus compounds of specific interest here, but the concept of lipophilic phosphorus compounds accommodates a much broader chemical diversity than only phospholipids. Further, the concept of lipophilic phosphorus compounds is applicable to all types of lipid feeds and P impurities contained within, also to such feeds that do not contain any phospholipids or derivatization or degradation products thereof.

Although phospholipids are the most discussed phosphorus impurities in oils and fats and formation of lipophilic phospholipid derivatives is an anticipated route for lipophilic P, the concept of lipophilic phosphorus is by no means limited to phospholipid origins. As the waste and residue character of the feeds increases, the possibility for contamination by other, yet undefined phosphorus sources, which as such may be lipophilic, or after further degradation reaction during treatment or logistics history of the lipid feed, may have become lipophilic although not originally having lipophilic precursors. Due to the lack of knowledge of the exact structures of many lipophilic phosphorus impurities, or the origin thereof, it is of high practical importance to be able to assess and quantify as a sum parameter these impurities, to be able to identify suitable industrial feeds with expected behavior of P purification challenges for catalytic hydrotreatment processing.

There is therefore a need to be able to assess and analyse lipophilic phosphorus compound(s) as impurities in feeds, to be able to identify suitable industrial feeds with expected behavior as to phosphorus compounds. Additionally, there is a need for reasoned selection of pretreatments to remove, minimize or at least control the amount of lipophilic phosphorus compound(s) therein.

### SUMMARY

The appended claims define the scope of protection. Any example or description of an apparatus, system, product, or process in the description, claim, and/or drawing which is not covered by the claims, is presented herein not as an embodiment of the invention but as background art or as an example useful for understanding the invention.

According to a first aspect is provided a process for producing renewable hydrocarbons suitable for use in fuel and biochemicals applications from a renewable feedstock comprising at least one or more lipophilic phosphorus compound(s), said process comprising the steps,
(i) providing the renewable feedstock, wherein the sum amount of the lipophilic phosphorus compound(s) calculated as elemental phosphorus is more than 2 wppm, of the total feedstock weight;
(ii) subjecting the renewable feedstock to at least one pretreatment to obtain a pretreated renewable feedstock, wherein the sum amount of the lipophilic phosphorus compound(s) calculated as elemental phosphorus is lower than that of the renewable feedstock in step (i), preferably less than 2 wppm, preferably less than 1.5 ppm, of the pretreated feedstock weight;
(iii) subjecting the pretreated renewable feedstock to at least one catalytic hydrotreating step to obtain the renewable hydrocarbons.

Preferably said steps are conducted in sequence (i), (ii), (iii). The present inventors have surprisingly found said process providing less deposit formation on catalysts in prolonged uses, and thus enhancing catalyst lifetime.

According to a second aspect is provided a use of a separation and an analysis in catalytic production of renewable hydrocarbons to provide data on at least one lipophilic phosphorus compound(s) in a renewable feedstock, the use further comprising based on said separation and analysis, selection of a pretreatment capable of reducing the lipophilic phosphorus compound(s) content beyond a critical level, and subjecting the renewable feedstock to the selected pretreatment to provide a pretreated renewable feedstock.

The present inventors have surprisingly found said use providing better control on the catalytic process by hydrotreating feedstocks with sufficiently low amount of lipophilic phosphorus compound(s), said pretreatment having been selected based on said data obtained through said separation and analysis.

Commonly for said first and second aspects, the present process and use provide means for selecting a suitable pretreatment or a combination of pretreatments for a feedstock by knowledge of the content of the lipophilic phosphorus compound(s) instead of the total phosphorus content, as evidenced by the results shown in the Examples.

### BRIEF DESCRIPTION OF THE FIGURES

Some example embodiments will be described with reference to the accompanying figures, in which:

FIG. 1 shows Lipophilic P (A and B) and amphiphilic P (C and D) model compound separation results by the SPE method plotting absorption intensity as a function of retention time.

FIG. 2 shows Lipophilic (A and B) and amphiphilic (C and D) model compound bleaching results.

FIG. 3 shows a separation result by SPE of a used cooking oil (UCO) sample.

FIGS. 4 and 5 provide schematic presentations of the embodiments of the general process.

### DETAILED DESCRIPTION

In the following description, like reference signs denote like elements or steps. All standards referred to herein are the latest revisions available at the filing date, unless otherwise mentioned.

When addressing phosphorus (P) generally in this context, it is understood to encompass any compound containing at least one phosphorus atom. In relation to analyses, such as total phosphorus content, it is expressed and calculated as elemental phosphorus. However, it is understood that in the feedstocks of interest phosphorus is bound to inorganic, and organic compounds, the structure, and characteristics of which depend on the feedstock type and origin. Standard methods for determining the total phosphorus content in a sample are known. For oil or fat samples an example of such method is Inductively Coupled Plasma (ICP) based determination, an example of which is ISO 10540-3:2002.

By lipophilic phosphorus compounds i.e. difficult to remove P compounds is meant herein phosphorus containing impurities that are not efficiently removed, or are only marginally removed, in conventional surface chemistry treatments such as degumming or bleaching. Even increasing adsorbent dosage or performing multiple bleaching steps in sequence will not improve purification to a desired level.

Without being bound by any theory it is anticipated that on the molecular level, it is likely that difficult to remove P has been formed by different pathways from different precursor molecules, meaning that difficult to remove P can encompass an array of molecules containing phosphorus that are difficult to remove. Lipophilic phosphorus can be derived from various origins and could also be for example an added phosphorus chemical, which is lipophilic. Structurally, it is believed that the difficult to remove P is lipophilic, i.e. it prefers staying in the lipid phase rather than going into a water phase or settling on the phase interfaces. Lipophilic phosphorus impurities may be chemically formed or transformed from originally amphiphilic compounds by the loss of the polar head groups, or they may become masked by structures of non-polar, organic character. By losing the molecule's amphiphilic properties, it is not anymore surface active and will not be susceptible to removal by surface phenomena, like micelle/gum formation in degumming, or adsorption in bleaching, and hence is not removed by methods based on surface phenomena.

By definition, the “lipophilic phosphorus compound(s)” refers herein to phosphorus derivatives that in an immiscible oil-water system or adsorbent-oil system, stay in the oil phase. Said lipophilic phosphorus compound(s) essentially show no interfacial surface activity to the oil phase interfaces under conditions which are typical for industrial degumming or bleaching processes.

When assessed quantitatively, in a stream, such as feedstock or pretreated feedstock, the amount of lipophilic phosphorus compound(s) may be expressed and calculated as elemental phosphorus per the total sample weight or volume, such as lipophilic fraction collected by SPE. Even though it is understood that different compounds are present, the identification of said compounds or knowing their individual amounts is secondary to the need to determine the sum amount of all lipophilic phosphorus compound(s) present. Hence, when referring to the amount of lipophilic phosphorus compound(s), it means said sum amount. For some purposes, it may be relevant to assess difference between treated and untreated sample and/or the ratio between the content of the lipophilic phosphorus compounds and the total phosphorus content.

In the experiments conducted, the solid phase extraction method provided at least one lipophilic and at least one amphiphilic fraction, each containing phosphorus compounds confirming the difference between phosphorus compounds having both lipophilic and hydrophilic parts in contrast to the lipophilic phosphorus compounds lacking hydrophilic heads. Of these, the lipophilic phosphorus compound(s) were recovered in the lipophilic fraction(s) only and not in the amphiphilic fraction(s). Hence, analysis on said lipophilic fraction(s) provides qualitative and quantitative information on the lipophilic phosphorus compound(s) in the feed in question. Equally, analyses e.g. before and after a pretreatment can provide information on the effect of said pretreatment.

Typically, the feedstocks as used herein, refer to renewable feedstocks i.e. feedstocks derived from raw material of biological origin. The sources for renewable feedstock are numerous including oils and/or fats, usually containing lipids (e.g. fatty acids or glycerides), such as plant oil/fats, vegetable oil/fats, animal oil/fats, algae oil/fats, fish oil/fats and algae oil/fats, or oil/fats from other microbial processes, for example, genetically manipulated algae oil/fats, genetically manipulated oil/fats from other microbial processes and also genetically manipulated vegetable oil/fats. Components derived from these materials may also be used, for example, alkyl esters, typically C1-C5 alkyl esters, such as methyl, ethyl, propyl, iso-propyl, butyl, sec-butyl esters, or olefins. Additionally, the renewable feedstock may include C1-C5 alkyl alcohols, particularly methyl, ethyl, propyl, iso-propyl, butyl, and/or sec-butyl esters of fatty acids, and any combinations thereof.

The renewable feedstock may additionally include free fatty acids, fatty acid esters (including mono-, di-, and triglycerides), or combinations thereof. For example, the free fatty acids may include free fatty acids obtained by stripping free fatty acids from a triglyceride transesterification feedstock. The renewable feedstock may include the fatty acid distillate from vegetable oil deodorisation.

Plant and/or vegetable oils and/or microbial oils may include babassu oil, carinata oil, soybean oil, canola oil, coconut oil, rapeseed oil, crude tall oil (CTO), tall oil (TO), tall oil fatty acid (TOFA), tall oil pitch (TOP), palm oil (PO), palm oil fatty acid distillate (PFAD), jatropha oil, palm kernel oil, sunflower oil, castor oil, camelina oil, archaeal oil, bacterial oil, fungal oil, protozoal oil, algal oil, seaweed oil, oils from halophiles, and mixtures of any two or more thereof. Animal fats and/or oils may include inedible tallow, edible tallow, technical tallow, floatation tallow, lard, poultry fat, poultry oils, fish fat, fish oils, and mixtures of any two or more thereof. Greases may include yellow grease, brown grease, waste vegetable oils, restaurant greases, trap grease from municipalities such as water treatment facilities, and spent oils from industrial packaged food operations, and mixtures of any two or more thereof. In the context of the present disclosure, the feedstocks are typically low grade and contain various impurities, such as waste and residues, materials not suitable for food, feed or cosmetics applications.

According to an embodiment, the renewable feedstock comprises at least one of acidulated soapstock, (ASK), poultry fat, dry rendered poultry fat (AFP), brown grease (BG), used cooking oil (UCO), tall oil, fraction of tall oil, crude tall oil (CTO), tall oil pitch (TOP), palm oil mill effluent (POME), crude palm oil (CPO), palm oil, palm seed oil, palm fatty acid distillate (PFAD), babassu oil, carinata oil, coconut butter, muscat butter oil, sesame oil, maize oil, poppy seed oil, cottonseed oil, soy oil, laurel seed oil, jatropha oil, palm kernel oil, camelina oil, archaeal oil, bacterial oil, fungal oil, protozoal oil, algal oil, seaweed oil, mustard seed oil, oils from halophiles, soybean oil (SBO), technical corn oil, rapeseed oil (RSO), colza oil, canola oil, sunflower oil, hemp seed oil, olive oil, linseed oil, mustard oil, peanut oil, castor oil, coconut oil, lard, tallow, train oil, spent bleaching earth oil (SBEO), lignocellulosic based feeds, or any mixture thereof.

In these feeds, some phosphorous compounds have been shown to be difficult to remove with common purification methods finding basis on surface chemistry and hence pose additional challenges. The waste and residue materials actually contain a wide variety of lipophilic phosphorus compounds. Animal fats, as a specific feedstock, comprise membrane residues etc. which have proven to be difficult to be removed from the feedstock stream.

The main source of phosphorous in bio-oils are phospholipids and inorganic phosphates, which especially in animal fats originate from bone meal. In addition, there may be some minor amounts of phosphorous impurities from other sources, e.g. DNA, RNA and ATP, and further the processing of the fat or oil may have promoted the formation of different types of organic phosphorous compounds, the identity of which are not known and which are hard to remove by degumming or bleaching. Phospholipids are generally removed by degumming, and further residual phospholipids can be adsorbed in the adsorption step in bleaching (the degumming mechanism also takes part in many bleaching sequences). Heat treatment has been found very efficient for degrading phospholipids (heat sensitive) so that they can be removed by filtering or bleaching. Phosphate in bone meal is generally present as solid particles and is removed by filtration e.g. in bleaching.

The oils and/or fats of biological origin may include a single kind of oil, a single kind of fat, mixtures of different oils, mixtures of different fats, mixtures of oil(s) and fat(s), fatty acids, glycerol, and/or mixtures of the aforementioned. Typically, when waste and residue material are used, they comprise mixtures of several components and accordingly, a miscellaneous range of varying lipophilic phosphorus compounds as impurities.

Fats, oils, and greases as feedstock may also contain further impurities, such as metals, mainly sodium, potassium, magnesium, calcium, iron, copper or combinations thereof. The common pretreatments based on surface chemistry are typically able to lower the amount of metal impurities. The feeds may further contain several heteroatoms, such as Cl, S and N, in varying amounts, occasionally even high amounts, depending on the origin of the feed. Heteroatoms can normally be handled by the available pretreatment methods or processing sequences as well.

The typical way of handling undesirable impurities in feedstocks, such as phosphorus impurities, is to pretreat the feedstock prior to hydrotreatment. It is simple to remove the water-soluble phosphorus compounds, such as inorganic or amphiphilic phosphorus through degumming. However, in certain animal fats, a significant part of the phosphorus compounds are lipophilic phosphorus compounds, and much more difficult to reduce or remove than the water-soluble or amphiphilic phosphorus compounds.

In the context of the present disclosure, hydrotreating is considered as the “main process” for the conversion of the feed into products. Therefore, treatment(s) to which the renewable feedstock is subjected to, specifically with the intention to lower the lipophilic phosphorus content, are referred to here as pretreatments.

Hydrotreatment refers to hydrodeoxygenation, hydrodesulfurisation, hydrodenitrogenation, hydrodehalogenation (such as hydrodechlorination), hydrogenation of double bonds, hydrocracking, hydroisomerisation, any combination thereof, and it also removes some metals. According to an embodiment, the catalytic hydrotreating comprises one or more of hydrodeoxygenation, hydroisomerisation and hydrocracking, simultaneously or in sequence. It is common that even though the main reaction is one of the above mentioned, further reactions take place as side reactions. Hence, some decarboxylation and/or decarbonylation might also appear. When aiming at fuel and/or biochemical production, typical sequences of hydrotreatment reactions are hydrodeoxygenation followed by hydroisomerisation, hydrodeoxygenation followed by hydrocracking and hydroisomerisation or hydrodeoxygenation followed by hydroisomerisation and hydrocracking.

According to an embodiment, the pretreated renewable feedstock is subjected to hydrotreating in the presence of a catalyst selected from Pd, Pt, Ni, Co, Mo, Ru, Rh, W, or any combination of these, such as CoMo, NiMo, NiW, CoNiMo, NiMoW or together with SAPO-11, SAPO-41, ZSM-22, ZSM-23, ZSM-12, ZSM-48, ZSM-5, beta zeolites, ferrierite and mixtures thereof, such as Pt/SAPO-11/Al₂O₃, Pt/ZSM-22/Al₂O₃, Pt/ZSM-23/Al₂O₃, Pt/SAPO-11/SiO₂, optionally on a support, wherein the support is preferably alumina and/or silica, and a liquid product comprising renewable hydrocarbons is recovered. Said catalysts can lose their activity if phosphate compounds, such as salts, form and precipitate thereon. Therefore, removal of lipophilic phosphorus compounds contributes to catalyst lifetime enhancement.

Avoiding catalyst deactivation, i.e. the loss over time of catalytic activity and/or selectivity, is a continuing aim in industrial catalytic processes. Costs to industry for catalyst replacement and process shutdown add up into considerable economic losses per year. Time scales for catalyst deactivation may vary considerably depending on the process and the catalyst types used. Some catalysts last for a few seconds whereas some may last for tens of years. Nevertheless, it is inevitable that all catalysts will eventually deactivate. Typically, the loss of activity and/or selectivity in a well-controlled process occurs slowly. However, process upsets or poorly designed hardware can bring about unexpected and early failures. While catalyst deactivation is inevitable for most processes, some of its drastic consequences may be avoided and at least postponed by the present process and use.

By deactivation of a catalyst is meant herein the gradual deterioration of the performance of the catalyst, which eventually reaches a level wherein it is no longer reasonable to continue the use of the catalyst. In this context reasonableness is best depicted by the ability to produce the product that fulfils the predefined quality and quantity criteria. In practice this means that each catalyst will confront a point of time when it is deactivated to an extent requiring a change of the spent catalyst to a fresh one. Thus, the deactivation can be described as the catalyst lifetime length per shutdown frequency. This ratio provides a measure for the ability to produce the final product in view of the needed shutdowns for a catalyst change due to deactivation. In other words, less production is lost in a given time frame if there are fewer shutdowns due to catalyst changes originating from catalyst deactivation.

Deactivation of the catalyst is typically defined as impurities residing on a catalyst surface, thus blocking the active sites of the catalyst from the feedstock molecules. Deactivation of the catalyst may be caused by fouling or poisoning of the catalyst. Fouling is generally considered to be related to deposition of insoluble components present in the feed or formed by degradation of the feed or reaction intermediates, whereas poisoning is related to the deposition of electropositive contaminants, such as alkali and alkaline earth metals, on acid sites or electronegative contaminants at hydrogenation sites.

The hydrodeoxygenation is preferably the first catalytic hydrotreatment in a sequence of hydrotreatments and conducted in the presence of a hydrodeoxygenation catalyst selected from Pd, Pt, Ni, Co, Mo, Ru, Rh, W, or any combination of these, such as CoMo, NiMo, NiW, CoNiMo, on a support, wherein the support is preferably alumina and/or silica.

The hydrodeoxygenation may take place at reaction conditions comprising a temperature in the range from 100 to 500° C., preferably from 250 to 400° C., more preferably from 280-350° C., most preferably at temperature of 300-330° C.

The hydrodeoxygenation may take place at reaction conditions comprising a pressure in the range from 0.1 to 20 MPa, preferably from 0.2 to 8 MPa.

Preferably, the weight hourly space velocity (WHSV) in the hydrodeoxygenation reaction a is in the range from 0.5 to 3.0 h-1, more preferably from 1.0 to 2.5 h-1, most preferably from 1.0 to 2.0 h-1. Preferably, H₂ flow is in the range from 350 to 900 nl H₂/l feed, more preferably from 350 to 750, most preferably from 350 to 500, wherein nl H₂/l means normal liters of hydrogen per liter of the feed into the HDO reactor, in the presence of a hydrodeoxygenation catalyst.

Hydrotreating may comprise hydrodeoxygenation and hydroisomerisation, simultaneously or in sequence. In a specific embodiment, hydrodeoxygenation and hydroisomerisation are performed simultaneously using a NiW catalyst.

When the pretreated feedstock is first subjected to HDO, the liquid product recovered therefrom is according to a preferred sequence of hydrotreatments next subjected to hydroisomerisation to produce branched paraffinic hydrocarbons. The hydroisomerisation is conducted in the presence of an hydroisomerisation catalyst containing a support, a metal and a further catalyst material, said support selected from Al₂O₃ and SiO₂, and said metal selected from Pt and Pd and Ni, and said further catalyst material selected from SAPO-11, SAPO-41, ZSM-22, ZSM-23, ZSM-12, ZSM-48, ZSM-5, beta zeolites and mixtures thereof. Such catalyst materials have been found to deactivate if lipophilic phosphorus compounds are not effectively removed, which deactivation may be at least partly prevented by pretreatment according to the present invention.

The hydroisomerisation step is preferably performed at a temperature from 250 to 400° C., more preferably from 280 to 370° C., most preferably from 300 to 350° C.

The hydroisomerisation may take place at reaction conditions comprising a pressure, which preferably is from 1 to 6 MPa, more preferably from 2 to 5 MPa, most preferably from 2.5 to 4.5 MPa.

The hydrodeoxygenation may take place at reaction conditions comprising a WHSV preferably from 0.5 to 3 h-1, more preferably from 0.5 to 2 h-1, most preferably from 0.5 to 1 h-1, and H₂ flow as in-liter H₂/liter feed, preferably from 100 to 800, more preferably from 200 to 650, most preferably from 350 to 500.

The isomerisation treatment is a step which predominantly serves to isomerise at least part of the hydrodeoxygenated raw material. That is, while most thermal or catalytic conversions (such as HDO) result in a minor degree of isomerisation (usually less than 5 wt-%), the isomerisation step leads to a significant increase in the content of i-paraffins.

During the conventional hydroisomerisation some cracking may be present. Therefore, the selection of the catalyst and optimisation of reaction conditions are always important during the isomerisation step. Due to cracking during isomerisation, renewable diesel and renewable aviation fuel components may be formed.

Hydroisomerisation can be carried out in a conventional hydroisomerisation unit. Hydrogen is added into the hydroisomerisation step. Both the hydrodeoxygenation step and hydroisomerisation step may be conducted in the same reactor in different reactor beds, or even in the same reactor bed.

As products, preferably as liquid products, hydrotreatment of the present feedstocks provides various hydrocarbons, preferably paraffinic, more preferably at least partly isoparaffinic hydrocarbons suitable for use in fuel applications. According to an embodiment, the renewable hydrocarbons suitable for use in fuel applications comprise components for renewable diesel, sustainable aviation fuel, renewable gasoline or any combination thereof, preferably at least one or more of renewable diesel component meeting the requirements for EN15490-2018 and sustainable aviation fuel component meeting the requirements for ASTM D7566-2020 Annex 2

Chemically the renewable or fossil origin of any organic compounds, including hydrocarbons, can be determined by a suitable method for analyzing the content of carbon from renewable sources e.g. DIN 51637 (2014), ASTM D6866 (2020), or EN 16640 (2017). Said methods are based on the fact that carbon atoms of renewable or biological origin comprise a higher number of unstable radiocarbon (14C) atoms compared to carbon atoms of fossil origin. The 14C-isotope content can be used as evidence of the renewable or biological origin of a feedstock, any intermediate or a product. Therefore, it is possible to distinguish between carbon compounds derived from biological sources, and carbon compounds derived from fossil sources by analysing the ratio of 12C and 14C isotopes. Thus, a particular ratio of said isotopes can be used to identify renewable carbon compounds and differentiate those from non-renewable i.e. fossil carbon compounds. The isotope ratio does not change in the course of chemical reactions. Example of a suitable method for analysing the content of carbon from biological sources is ASTM D6866 (2020). An example of how to apply ASTM D6866 to determine the renewable content in fuels is provided e.g. in the article of Dijs et al., Radiocarbon, 48(3), 2006, pp 315-323. For the purpose of the present invention, a carbon-containing material, such as a feedstock or product is considered to be of renewable origin if it contains 90% or more modern carbon (pMC), such as about 100% modern carbon, as measured using ASTM D6866.

According to a first aspect, herein is provided a process for producing renewable hydrocarbons suitable for use in fuel applications from a renewable feedstock comprising at least one or more lipophilic phosphorus compound(s), said process comprising the steps,
(i) providing the renewable feedstock, wherein the sum amount of the lipophilic phosphorus compound(s) calculated as elemental phosphorus is more than 2 wppm, however lower than 50 wppm of the total feedstock weight;
(ii) subjecting the renewable feedstock to at least one pretreatment to obtain a pretreated renewable feedstock, wherein the sum amount of the lipophilic phosphorus compound(s) calculated as elemental phosphorus is lower than that of the renewable feedstock in step (i), preferably less than 2 wppm, preferably less than 1.5 ppm, such as from 1.5 to 0.1 wppm, of the pretreated feedstock weight;
(iii) subjecting the pretreated renewable feedstock to at least one catalytic hydrotreating step to obtain the renewable hydrocarbons.

The present inventors have found the amount of at least one or more lipophilic phosphorus compound(s) providing an excellent indicator of the ability of conventional pretreatment method(s) to remove phosphorus from the feedstock. Further, it is an important indicator of the feedstock quality. Yet further, it indicates whether the feedstock is safe and ready to be fed to hydrotreatment catalyst or whether pretreatment(s) to lower said lipophilic phosphorus compound(s) content is needed, in other words, suitable to be directed into hydrotreatment without unduly deactivating the catalyst and/or shortening the HDO catalyst life time, naturally provided that the total P content is at a reasonable level.

As to the sum amount of the lipophilic phosphorus compound(s) in the renewable feedstock, the present invention has proven to provide the best results as to lowering the catalyst deactivating compounds when the sum amount of the lipophilic phosphorus compound(s) calculated as elemental phosphorus is more than 1 wppm, however typically more than 2 wppm, such as from 2 wppm to 50 wppm, of the total renewable feedstock weight. It is understood that in cases where the sum amount of the lipophilic phosphorus compound(s) calculated as elemental phosphorus is only slightly more than 1 wppm, such as from 1 to 2 wppm, the sum amount of the lipophilic phosphorus compound(s) in the pretreated renewable feedstock is lower than that of the renewable feedstock in step (i), then preferably less than 1 wppm, such as from 1 to 0.1 wppm of the pretreated feedstock weight. Renewable feedstocks having sum amount of the lipophilic phosphorus compound(s) calculated as elemental phosphorus of more than 50 wppm are of very low quality and therefore either unsuitable for the present process or require heavier treatments for purification.

Typically, one pretreatment is sufficient when selected based on information on the lipophilic phosphorus compound content therein. However, according to an embodiment, two or more feedstock pretreatments are conducted in sequence in step (ii). A combination of two or more pretreatments may be needed in cases where the amount of lipophilic phosphorus compound(s) is exceptionally high, or the lipophilic phosphorus compounds comprise several compound types responding differently to the pretreatments, in the renewable feedstock before any treatment(s).

In step (ii), in the pretreated renewable feedstock the sum amount of the lipophilic phosphorus compound(s) calculated as elemental phosphorus is lower than that of the renewable feedstock in step (i). Preferably in the pretreated renewable feedstock the sum amount of the lipophilic phosphorus compound(s) calculated as elemental phosphorus is less than 2 wppm, preferably less than 1.5 wppm, such as from 1.5 to 0.1 wppm, of the pretreated renewable feedstock weight. Feeds having a sum amount of the lipophilic phosphorus compound(s) more than 2 wppm would ruin the catalyst activity within months leading to costly downtime and need for catalyst regeneration. The present experiments have shown attractively low sum amounts of the lipophilic phosphorus compound(s), such as less than 2 wppm (Example 4) being obtainable by pretreatment sequence of heat treatment followed by bleaching for several animal fat samples where the sum amount of lipophilic phosphorus compounds in the feedstock initially varied roughly from about 5 to nearly about 25 wppm.

For the present feedstocks, a wide range of pretreatments with a great variety of modifications are available in the field as such. According to preferred embodiments, the feedstock pretreatment is, or the pretreatments are, selected from degumming, heat treatment, high temperature adsorption (HTA), acid treatment, filtration, bleaching, blending or any combination thereof. With the present process for selecting a pretreatment based on determining the amount of the lipophilic phosphorus compound(s), the hydrotreatment catalysts may be best protected against deactivation and the catalyst life extended. Further, excessive pretreatments, which unavoidably lead to increased processing cost and yield loss, can be prevented. Selection of the pretreatment(s) is dependent e.g. on the feed composition, impurity profile, and impurity amounts present. For example, for specific feedstocks, the heat treatment was found to remove lipophilic phosphorus compounds efficiently from the feedstocks, but in some other cases it might be redundant should the analyses reveal that of the total phosphorus content, only a marginal portion is of lipophilic phosphorous. Hence, performing the necessary but only the necessary pretreatments lead to a more effective and economic process.

In one embodiment the pretreatment is selected from heat treatment optionally followed by evaporation of volatiles, whereby the feedstock is heated at a temperature of from 80° C. to 325° C., preferably 180° C. to 300° C., more preferably 200° C. to 280° C., in a residence time from 1 to 300 min. The heat treatment can be followed by an evaporation step, where especially silicon containing compounds are removed. An example of heat treatment of a feedstock comprising organic material can be found in WO 2020/016405. Heat treatment can also be followed by filtration as an addition or an alternative to evaporation. When the feedstock comprises brown grease or acidulated soapstock the pretreatment comprising heat treatment with or without filter-aid (adsorbent) may be used followed by filtration and possible bleaching.

In one embodiment the pretreatment is selected from heat treatment with adsorbent (HTA) optionally followed by flash evaporation. HTA as pretreatment is especially suitable when the feedstock comprises CTO and/or TOP, but also for another feedstock. Heat treatment with adsorbent (HTA) can be performed in a temperature from 180° C. to 325° C., preferably from 200° C. to 300° C., more preferably from 240° C. to 280° C., optionally in the presence of an acid. The adsorbent can be selected from alumina silicate, silica gel and mixtures thereof and is typically added in an amount of 0.1 wt. % to 10 wt. %, such as 0.5 wt. %. An example of HTA can be found in WO 2020/016410. Heat treatment with adsorbent (HTA) can also be referred to as high temperature adsorption, heat treatment with adsorption, or heat treating in the presence of adsorbent.

In one embodiment the pretreatment is selected from bleaching. Bleaching can be conducted by acid addition in an amount of from 500 to 5000 ppm based on feed. The bleaching treatment can be performed in a temperature from 60° C. to 90° C. and including a drying step in 110° C. to 130° C. at a reduced pressure. The bleaching is finished by a filtration step to remove formed solids and possible adsorbents and filter aids. In one example bleaching includes the following sequence
(1) acid addition 1000-4000 ppm citric acid (50% aqueous solution), 85° C., 10 min;
(2) adsorbent/filter aid addition 0.1-1 wt. %, 85° C., 800 mbar, 20 min;
(3) drying 120° C., 80 mbar, 25 min
(4) filtering 120° C., 2.5 bar.

Both heat treatment (HT) and heat treatment with adsorbent (HTA) can be performed under pressure, the pressure can be from 10 to 5000 kPa or such as from 150 to 800 kPA. Also, water can be added before or during HT and HTA to a level of up to 5 wt. %, such as 1 wt. %-3 wt. %. The evaporation, e.g. performed by flashing can be performed after HT or HTA or any other pretreatment stage and can be performed at about 160° C., such as from 150° C. to 225° C., in a pressure of 10 to 100 mbar (1 to 10 kPa).

For a feedstock comprising palm oil mill effluent sludge (POME) the pretreatment can comprise acid degumming followed by solid removal from the liquid, using filtration or centrifugation. The degumming process can further be followed by a bleaching step.

In one embodiment of the invention the pretreatment comprises heat treatment (HT) followed by bleaching.

In one embodiment of the invention the pretreatment comprises heat treatment (HT) with alkali addition and bleaching.

In one embodiment of the invention the pretreatment, comprises heat treatment with adsorbent (HTA) followed by bleaching, or optionally followed by flash (removal of light components comprising Si components etc. by evaporation) and bleaching,

In addition, the pretreatment may or may not include additional steps such as removal of solids (using technologies such as centrifugation or filtration) before and/or after HT or HTA, water washing, degumming, hydrolysis, distillation, strong acid treatment, 2nd or further bleaching or any combination of the mentioned methods.

In a preferred embodiment, bleaching is the last step of a pretreatment sequence. Bleaching can be considered as polishing treatment leaving the pretreated feed ready for hydrotreatment steps. However, bleaching alone cannot remove high impurity levels from very dirty feedstocks.

In one embodiment of the invention the pretreatment comprises blending the feedstock with a second feedstock having a sum amount of lipophilic phosphorus compound(s) which is lower than that of the feedstock to be treated. Blending is considered most beneficial if conducted in a sequence of pretreatment as early as possible, but it can take place at any stage. To be able to calculate appropriate blend proportions, the sum amount of lipophilic phosphorus compound(s) needs to be analysed from both the feedstock to be treated and the second feedstock. Analysing total phosphorus content would be insufficient.

According to a specific embodiment, the combination of pretreatments consists of combination of blending and heat treatment, preferably in said sequence. However, combination of heat treatment and blending in this order may be beneficial in case the heat treatment capacity is limiting the overall process volume. Heat treatment provided promising results in the experiments conducted with analyses on the lipophilic phosphorus compounds and with some pretreatment methods applied.

According to another specific embodiment, the combination of pretreatments consists of combination of heat treatment with adsorbent and blending, preferably in said sequence. However, combination of heat treatment with adsorbent and blending in this order may be beneficial in case the process capacity is limited.

According to an embodiment, at least one pretreatment step is selected based on data on pretreatments' capability on reducing the sum amount of the lipophilic phosphorus compound(s) in a feedstock; and subjecting the renewable feedstock to at least one pretreatment thereby selected. The data on which the pretreatment selection is based, can be obtained from experiments or full-scale runs where the lipophilic phosphorus compounds have been analysed, e.g. from both the feedstock and from the pretreated feedstock.

For the present experiment, an analysis method was developed. It was found that instead of or further to analysing the total phosphorus content, a specific analysis on the lipophilic fraction provided most relevant information for the pretreatment selection. Hence, according to an embodiment, determining the sum amount of the lipophilic phosphorus compound(s) is conducted by an analysis comprising separating at least one fraction containing the lipophilic phosphorus compound(s), and analysing said fraction to provide data on the sum amount of the lipophilic phosphorus compounds in said renewable feedstock or said pretreated renewable feedstock. In practice, the analysis is typically conducted to a sample collected from said feedstock, pretreated feedstock, any intermediate between pretreatments and/or a combination thereof. However, collecting a sample may be replaced by any means, such as microchip or like, providing corresponding analysis result.

Further to the fraction containing the lipophilic phosphorus compound(s), preferably said analysis comprises collecting at least one amphiphilic fraction. Collecting these two fractions with the aid of an appropriate solvent system, contributes to more specific analysis.

According to an embodiment, said separating comprises solid phase extraction (SPE) or flash chromatography, In the present experiments SPE proved efficient.

According to an embodiment, the SPE comprises use of a solvent system, preferably wherein the extraction is made with a set of solvents with increasing polarity of solvents in the solvent system.

According to an embodiment, the phosphorus content in the separated fraction is analysed by a quantitative mass spectrometry analysis, preferably an inductively coupled plasma mass spectrometry (coupled ICP-MS).

As a second aspect, the present invention describes a use of a separation and an analysis in catalytic production of renewable hydrocarbons to provide data on at least one lipophilic phosphorus compound(s) in a renewable feedstock, the use further comprising based on said separation and analysis, selection of a pretreatment capable of reducing the lipophilic phosphorus compound(s) content and subjecting the renewable feedstock to the selected pretreatment to provide a pretreated renewable feedstock.

According to an embodiment, the sum amount of the lipophilic phosphorus compound(s) calculated as elemental phosphorus is lower than that of the renewable feedstock, preferably less than 2 wppm, more preferably less than 1.5 wppm, such as from 1.5 wppm to 0.1 wppm, of the pretreated renewable feedstock weight.

According to an embodiment, the separation and an analysis comprises steps of
(a) collecting at least one sample of said renewable feedstock containing lipophilic phosphorus compound(s);
(b) separating from said sample at least one fraction containing the lipophilic phosphorus compound(s), and
(c) analysing said fraction to provide data on the sum amount of the lipophilic phosphorus compound(s) in said renewable feedstock.

According to an embodiment, said separating in step (b) comprises solid phase extraction (SPE) or flash chromatography, preferably SPE.

According to an embodiment, the use further comprises subjecting the pretreated renewable feedstock to at least one catalytic hydrotreating to obtain renewable hydrocarbons.

According to an embodiment said separation and said analysis in catalytic production of renewable hydrocarbons to provide data on at least one lipophilic phosphorus compound(s) in a renewable feedstock are used for reducing the loss of hydrotreatment catalyst activity.

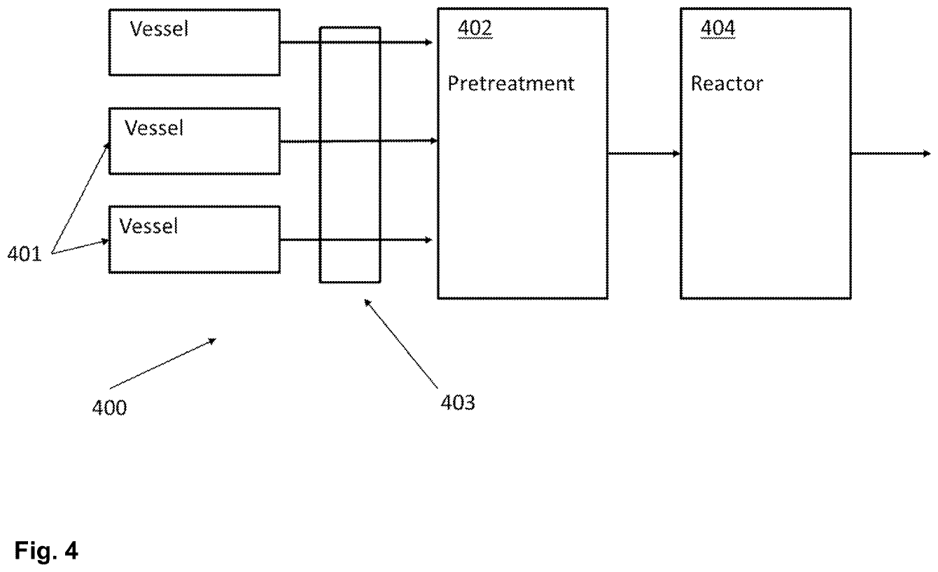

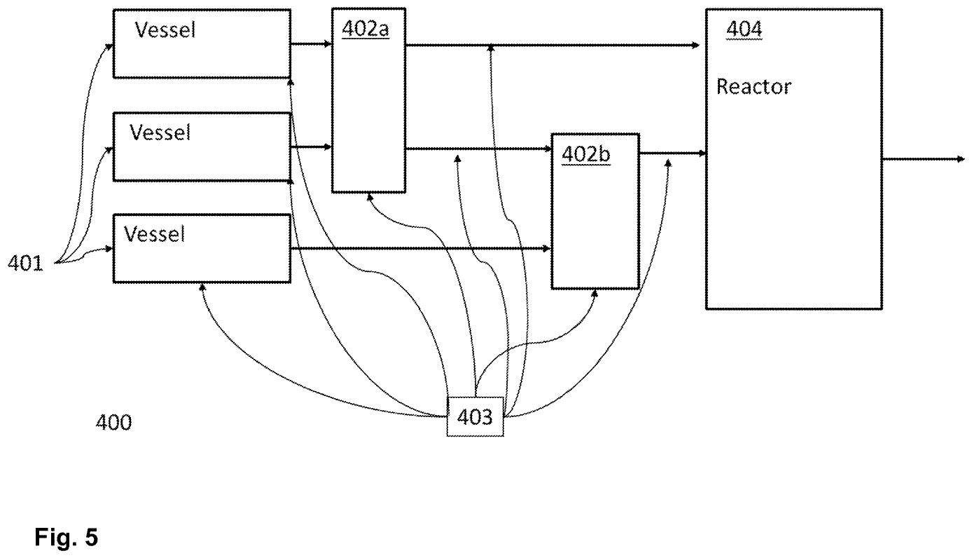

### FIGS. 4 and 5

The present process and use are next described with reference to appended FIGS. 4 and 5 in the form of a schematic system for preparing or manufacturing hydrocarbons. An exemplary embodiment of the system 400 is shown in FIG. 4 and another in FIG. 5. As can be appreciated from said figures, the system 400 can include at least one vessel 401 for storage of a renewable feedstock comprising lipophilic phosphorous compounds. The system can also include at least one sample extraction mechanism 403 that is configured for extraction of samples of feedstock before the renewable feedstock is accepted or fed to at least one pretreatment device 402 and/or a hydrotreatment reactor system 404. Further samples may be taken before or after any pretreatment device 402 and/or before hydrotreatment reactor system 404. The feedstock from one or more vessels 401 can be fed to at least one pretreatment device 402 to undergo pretreatment prior to being fed to the hydrotreatment reactor system 404. The hydrotreatment reactor system 404 can be positioned to receive the pretreated renewable feedstock from any pretreatment device 402 such that the renewable feedstock fed to the hydrotreatment reactor system 404 is subjectable to a hydrotreatment process(es) to form hydrocarbons in at least one catalytic reaction employing a catalyst. The hydrotreatment reactor system 404 may comprise at least one catalyst bed in at least one reactor but may comprise multiple catalyst beds having same or different hydrotreatment activity in a same or different reactors.

A content of the lipophilic phosphorous compounds in the pretreated renewable feedstock subjectable to the hydrotreatment process can be in a range of less than or equal to 2 parts per million by weight (wppm), so that deactivation of the catalyst is reduced or avoided. Each sample extraction mechanism 403 can be configured to extract feedstock samples for analysis. The analysis that is performed can identify aspects of the P impurity within the feedstock(s) for selection of which pretreatment device(s) 402 to utilize for the feedstock for pretreating the feedstock before it is fed to the hydrotreatment reactor system 404 for formation of hydrocarbons. The selected pretreatment device(s) 402 can include at least one pretreatment device 402 positioned between the vessel(s) 401 and the hydrotreatment reactor system 404 to pretreat the renewable feedstock(s) of the vessel(s) via at least one pretreatment process to lower the content of the lipophilic phosphorous compounds within the renewable feedstock before the renewable feedstock is passed to the hydrotreatment reactor system 404.

For instance, the selected pretreatment processing can include degumming and/or heat treatment followed by bleaching, only application of a heat treatment, only application of degumming and/or bleaching, a blending of multiple feedstocks from multiple vessels prior to undergoing further pretreatment via another pretreatment device 402, or other suitable pretreatment processing as discussed herein for effectively lowering the P content to within a pre-selected P content range. For example, the at least one pretreatment device 402 can be configured to perform one or more of: degumming, heat treatment, heat treatment with adsorbent (HTA), acid treatment, filtration, bleaching, bleaching with adsorbent, and/or blending. Embodiments of the system 400 can be configured to utilize a process for producing renewable hydrocarbons suitable for use in fuel applications from a renewable feedstock comprising at least one or more lipophilic phosphorus compound(s).

Embodiments of the present invention are next presented in a form of numbered items.
1. A method for preparing hydrocarbons, the method comprising:
   subjecting a renewable feedstock comprising lipophilic phosphorus compounds to a hydrotreatment process to form hydrocarbons from the renewable feedstock;
   wherein a content of the lipophilic phosphorus compounds in the renewable feedstock is in a range of between less than 2 parts per million by weight (wppm) and 0.1 wppm so that deactivation of a catalyst used in the hydrotreatment process is reduced or avoided.
2. The method of item 1, comprising:
   evaluating the renewable feedstock before the renewable feedstock is subjected to the hydrotreatment process to determine the content of the lipophilic phosphorus compounds in the renewable feedstock; and
   in response to a determination that the content of the lipophilic phosphorus compounds in the renewable feedstock is greater than a pre-selected lipophilic phosphorus content threshold, pretreating the renewable feedstock via at least one pretreatment process to lower the content of the lipophilic phosphorus compounds within the renewable feedstock so the content of the lipophilic phosphorus compounds in the renewable feedstock is less than 2 wppm and greater than or equal to 0.1 wppm or is less than 1.5 wppm and greater than or equal to 0.1 wppm.
3. The method of item 2, wherein the at least one pretreatment process includes degumming, heat treatment, acid treatment, filtration, bleaching, heat treatment with adsorbent (HTA), blending or any combination thereof.
4. The method of item 1, wherein the renewable feedstock is a first renewable feedstock, the method comprising:
   evaluating a second renewable feedstock before the first renewable feedstock is subjected to the hydrotreatment process to determine the content of the lipophilic phosphorus compounds in the second renewable feedstock;
   in response to a determination that the content of the lipophilic phosphorus compounds in the second renewable feedstock is greater than a pre-selected lipophilic phosphorus content threshold, performing at least one of:
      blending the second renewable feedstock with at least one third renewable feedstock to form a blended renewable feedstock so the content of the lipophilic phosphorus compounds in the blended renewable feedstock is lower than the content of the lipophilic phosphorus compounds in the second renewable feedstock and is at or below the pre-selected lipophilic phosphorus content threshold; and/or
      pretreating the second renewable feedstock or the blended renewable feedstock to lower the content of the lipophilic phosphorus compounds therein;
   wherein the blending and/or pretreating is performed to form the first renewable feedstock for subjecting the first renewable feedstock to the hydrotreatment process.
5. The method of item 1, comprising:
   analyzing the content of the lipophilic phosphorus compounds in the renewable feedstock.
6. The method of item 5, wherein the analyzing of the content of the lipophilic phosphorus compounds in the renewable feedstock comprises:
   collecting at least one sample of the renewable feedstock;
   separating from the sample at least one fraction including the lipophilic phosphorus compounds, and
   analyzing the at least one fraction to provide data on the content of the lipophilic phosphorus compounds in the renewable feedstock.
7. The method of item 6, wherein the separating from the sample at least one fraction including the lipophilic phosphorus compounds comprises solid phase extraction (SPE),
   the separating from the sample being performed such that at least one amphiphilic fraction is also collected; and
   the SPE comprises use of a solvent system such that a polarity of solvents in the solvent system increases during the SPE.
8. The method of item 7, wherein the analyzing of the at least one fraction including the lipophilic phosphorus compounds comprises at least one of:
   a quantitative analysis to provide quantitative data on lipophilic phosphorus compounds;
   a quantitative mass spectrometry analysis, and/or
   an inductively coupled plasma mass spectrometry analysis.
9. The method of item 1, comprising:
   evaluating the renewable feedstock before the renewable feedstock is subjected to the hydrotreatment process to determine the content of lipophilic phosphorus compounds in the renewable feedstock; and
   in response to a determination that the content of the lipophilic phosphorus compounds in the renewable feedstock is greater than a pre-selected lipophilic phosphorus content threshold, selecting at least one pretreatment process to pretreat the renewable feedstock to lower the content of the lipophilic phosphorus compounds within the renewable feedstock so the content of the lipophilic phosphorus compounds in the renewable feedstock is less than 2 wppm and greater than or equal to 0.1 wppm, the selecting being based on results from the evaluating of the renewable feedstock.
10. The method of item 1, wherein the hydrotreatment process includes one or more of hydrodeoxygenation, hydrodecarboxylation, hydrodecarbonylation, hydroisomerisation and hydrocracking.
11. A system for preparing hydrocarbons, the system comprising:
   a vessel for storage of a renewable feedstock comprising lipophilic phosphorus compounds;
   a hydrotreatment reactor positioned to receive the renewable feedstock from the vessel such that the renewable feedstock fed to the hydrotreatment reactor is subjectable to a hydrotreatment process to form hydrocarbons in a catalytic reaction employing a catalyst, a content of the lipophilic phosphorus compounds in the renewable feedstock subjectable to the hydrotreatment process being in a range of less than 2 parts per million by weight (wppm) and greater than or equal to 0.1 wppm so that deactivation of the catalyst is reduced or avoided.
12. The system of item 11, comprising:
   at least one pretreatment device positioned between the vessel and the hydrotreatment reactor to pretreat the renewable feedstock via at least one pretreatment process to lower the content of the lipophilic phosphorus compounds within the renewable feedstock before the renewable feedstock is passed to the hydrotreatment reactor.
13. The system of item 12, wherein the at least one pretreatment device is configured to perform one or more of: degumming, heat treatment, acid treatment, filtration, bleaching, heat treatment with adsorbent (HTA), and/or blending.
14. A renewable feedstock for being subjected to a hydrotreatment process to form hydrocarbons, comprising:
   a renewable feedstock formed from at least one renewable source, the renewable feedstock comprising lipophilic phosphorus compounds, a content of the lipophilic phosphorus compounds in the renewable feedstock being in a range of less than 2 parts per million by weight (wppm) and greater than or equal to 0.1 wppm so that deactivation of catalyst used in the hydrotreatment process is reduced or avoided.
15. The renewable feedstock of item 14, wherein the at least one renewable source includes one or more of:
   rapeseed oil, colza oil, canola oil, tall oil, sunflower oil, soybean oil, hempseed oil, cottonseed oil, corn oil, olive oil, linseed oil, mustard oil, palm oil, peanut oil, castor oil, coconut oil, camellia oil, jatropha oil, an oil derived from a microbial source, animal fat, fish oil, lard, tallow, train oil, oil derived from bacteria, oil derived from mold, oil derived from filamentous fungi, recycled fat from at least one industrial food source, and a mixture thereof.
16. A method for selecting a renewable feedstock for use in forming hydrocarbons, the method comprising:
   evaluating the renewable feedstock before the renewable feedstock acquired for use in a hydrotreatment process to form the hydrocarbons, the evaluating being performed to determine a content of lipophilic phosphorus compounds in the renewable feedstock;
   in response to a determination that the content of the lipophilic phosphorus compounds in the renewable feedstock is greater than a pre-selected lipophilic phosphorus content threshold, evaluating whether the renewable feedstock is pretreatable to lower the content of the lipophilic phosphorus compounds within the renewable feedstock so the content of the lipophilic phosphorus compounds in the renewable feedstock is in a range of less than 2 parts per million by weight (wppm) and greater than or equal to 0.1 wppm,
   in response to determining that the renewable feedstock is pretreatable to lower the content of the lipophilic phosphorus compounds in the renewable feedstock to within the range of less than 2 wppm and greater than or equal to 0.1 wppm, accepting or acquiring the renewable feedstock for use in a process to form the hydrocarbons.
17. The method of item 16, comprising:
   pretreating the renewable feedstock via one or more of: degumming, heat treatment, acid treatment, filtration, bleaching, heat treatment with adsorbent (HTA), blending or any combination thereof.
18. The method of item 16, wherein the evaluated renewable feedstock is a first renewable feedstock, the method also comprising:
   evaluating a second renewable feedstock before the first renewable feedstock is subjected to a hydrotreatment process to determine a content of lipophilic phosphorus compounds in the second renewable feedstock;
   in response to a determination that the content of the lipophilic phosphorus compounds in the second renewable feedstock is less than a pre-selected lipophilic phosphorus content threshold, performing at least one of:
      blending the second renewable feedstock with the first renewable feedstock to form a blended renewable feedstock so the content of the lipophilic phosphorus compounds in the blended renewable feedstock is lower than the content of the lipophilic phosphorus compounds of the first renewable feedstock and the content of the lipophilic phosphorus compounds in the blended renewable feedstock is at or below the pre-selected lipophilic phosphorus content threshold for forming a hydrotreatment feed to feed to a hydrotreatment process; or
      pretreating the first renewable feedstock to lower the content of the lipophilic phosphorus compounds therein for subsequent blending with the second renewable feedstock for forming a hydrotreatment feed to feed to a hydrotreatment process, the hydrotreatment feed having a content of the lipophilic phosphorus compounds therein that is at or below the pre-selected lipophilic phosphorus content threshold.
19. The method of item 18, wherein the pretreating of the first renewable feedstock comprises degumming, heat treatment, acid treatment, filtration, bleaching, heat treatment with adsorbent (HTA), or any combination thereof.
20. The method of item 16, wherein the evaluating the renewable feedstock comprises:
   analyzing the content of the lipophilic phosphorus compounds in the renewable feedstock, the analyzing comprising:
   collecting at least one sample of the renewable feedstock;
   separating from the sample at least one fraction including the lipophilic phosphorus compounds, the separating from the sample at least one fraction including the lipophilic phosphorus compounds including solid phase extraction (SPE), the separating from the sample being performed such that at least one amphiphilic fraction is also collected, and the SPE comprises use of a solvent system such that a polarity of solvents in the solvent system increases during the SPE and
   analyzing the at least one fraction to provide data on the content of the lipophilic phosphorus compounds in the renewable feedstock, the analyzing of the at least one fraction including at least one of:
   a quantitative analysis to provide quantitative data on the lipophilic phosphorus compounds;
   a quantitative mass spectrometry analysis, and/or
   an inductively coupled plasma mass spectrometry analysis.

### EXAMPLES

The following examples are provided to better illustrate the claimed invention. They are not to be interpreted as limiting the scope of the invention, which is determined by the claims. To the extent that specific materials are mentioned, it is merely for purposes of illustration and is not intended to limit the invention. One skilled in the art may develop equivalent means or reactants without exercising inventive capacity and without departing from the scope of the invention. It shall be understood that many variations can be made in the procedures described herein while remaining within the scope of the present invention. All exemplary materials and parameters used in the examples below are compatible with the present method and products.

The present experiments describe a method for extraction and quantification of lipophilic P from renewable feedstocks. An automated solid phase extraction (SPE) based method was developed for CombiFlash NextGen 300+ system (Teledyne ISCO) which is equipped with four solvent inlet ports, an evaporative light scattering (ELS) and UV-vis detectors. It can be coupled with various types and sizes of commercial separation columns prior to the detection.

In this disclosure, a 24 g gold grade silica column was used as stationary phase, and heptane, iso-propanol, methanol, and their mixtures were used as solvents of increasing polarity (mobile phase) for fractional extraction. The lipophilic and amphiphilic fractions can be determined based on the ELS detector, and their amounts can be quantified by weight after the removal (by rotavapor) of solvents. The method can be used for determining the lipophilic content in lipid-based feedstocks as well as pretreated products thereof, e.g. bleaching products, aging products.

### Example 1: Identifying Samples with High Lipophilic Phosphorus Compounds Content

Seven bio-oil samples were analysed for their total phosphorus content (e.g. using ICP-MS/MS with microwave degradation of sample prior to analysis) and further analysed for their content (sum amount) of lipophilic phosphorus compound(s) according to the disclosed SPE method (Example 5).

The results showed that most of these feeds contained 1-2 wppm of lipophilic phosphorus compounds and that the lipophilic phosphorus compounds usually constituted <10% of the total P concentration. However, one brown grease sample was found to have a very high lipophilic phosphorus compounds content (27 wppm, corresponding to 23%-wt of the total P), suggesting serious challenges for catalytic hydroprocessing and for the feed purification with typically used pretreatments such as degumming or bleaching. Brown grease is known as a very challenging lipid feed class, an explanation for which in relation to the phosphorus compounds was confirmed in this analysis and can be seen in Table 1.

Analysis results providing total phosphorus content (P tot (wppm)), lipophilic phosphorus content (Lipophilic P (wppm)) and the share of the lipophilic phosphorus content of the total phosphorus content as a percentage are given in Table 1.

TABLE 1
Analysis results for seven lipid feed examples as to their
phosphorus contents.

| | P tot | Lipophilic P | Lipophilic P |
|---|---|---|---|
| Feed | (wppm) | (wppm) | (% of P tot) |
| Animal fat | 110 | 1.6 | 1 |
| Used cooking oil | 15 | 1.5 | 10 |
| Brown grease | 120 | 27 | 23 |
| Technical corn oil | 30 | 1.6 | 5 |
| Vegetable acid oil | 170 | 1.7 | 1 |
| Tall oil pitch | 35 | 2.6 | 7 |
| Crude tall oil | 20 | 1.5 | 8 |

As seen from Table 1 the total phosphorus content varies from 15 to 170 wppm, being highest for vegetable acid oil and lowest for used cooking oil. However, despite their different total P contents, their content of lipophilic phosphorus is close to one another with exception of the brown grease. Further, even though the total P contents of animal fat and brown grease seem relatively similar (110 and 120 wppm), from the point of view of the catalyst life-time, their effect is very different. It was found that after e.g. common degumming pretreatment, the brown grease would thus have a much more detrimental impact on the catalyst lifetime than animal fat. From the last column, it can be seen how the proportions of the lipophilic phosphorus compounds in relation to the total phosphorus content vary in different samples.

### Example 2: Further Feed Samples

Further samples were analysed by the same method showing even greater variability between the different samples. They were measured from real-life feed samples. Even though they could be classified based on their origin (plant or animal) and refining process, the variation between samples of the same class revealed their true character and unpredictability as waste and residue materials. The analysed lipophilic phosphorus compound contents for samples of used cooking oil (UCO), palm oil mill effluent (POME), animal fat (AF), brown grease (BG), combinations thereof and/or bleaching products (BL) thereof, are given in Table 2. Based on the analysis results, such as those presented in Table 2, feeds requiring pretreatment, such as blending, can be spotted. Further, an appropriate blending partner can be selected based on such analysis results. Knowledge on sum amount of the lipophilic phosphorus compounds in a sample enables calculations required for pretreatment by blending and or optionally selection of conditions for other pretreatments.

TABLE 2
Further lipophilic phosphorus content results from
different feedstock samples.

| | | Lipophilic | Lipophilic P |
|---|---|---|---|
| | Total P | P | of the total P |
| Sample Type | wppm | wppm | [wt-%] |
| UCO | 9.6 | 0.8 | 8.0% |
| UCO | 7.7 | 1.5 | 19.0% |
| UCO | 11.0 | 3.6 | 33.0% |
| UCO | 13.0 | 2.0 | 15.0% |
| UCO | 17.0 | 2.0 | 12.0% |
| POME | 15.0 | 3.0 | 20.0% |
| POME | 4.0 | 0.6 | 15.0% |
| POME | 2.5 | 0.9 | 36.0% |
| UCO(10)-AF(90) | 35.0 | 0.8 | 2.0% |
| UCO(10)-AF(90) | 34.0 | 1.0 | 3.0% |
| UCO(10)-AF(90) | 39.0 | 0.9 | 2.0% |
| UCO-BL | 2.3 | 0.8 | 36.0% |
| UCO-BL | 3.9 | 2.5 | 65.0% |
| UCO-BL | 1.9 | 0.9 | 46.0% |
| UCO-BL | 5.2 | 1.6 | 30.0% |
| UCO-BL | 12.0 | 2.3 | 19.0% |
| UCO-BL | 2.4 | 1.6 | 65.0% |
| UCO(10)-AF(90)-BL | 2.7 | 1.1 | 41.0% |
| UCO(10)-AF(90)-BL | 1.9 | 1.4 | 76.0% |
| UCO(10)-AF(90)-BL | 2.2 | 1.1 | 52.0% |
| BG-BL | 8.7 | 1.5 | 18.0% |
| AF-BL | 1.0 | 0.6 | 62.0% |
| POME-BL | 16.0 | 0.9 | 6.0% |
| POME-BL | 7.8 | 1.1 | 14.0% |

The above results identified in Table 2 indicate the variability of phosphorus impurity contents that can be included in a feedstock. Lipophilic phosphorus, which may be more difficult to remove via pretreatment, can surprisingly make up a large portion of the overall phosphorus content within a feed that can make it unsuitable for effective pretreatment for subsequent use in hydrotreatment. Identification of this condition can allow for a more effective feed selection and/or pretreatment selection. For example, pretreatment via blending can be employed for high lipophilic phosphorus content feedstock to help lower the overall lipophilic phosphorus content within a feed prior to that feed being fed to a hydrotreatment process. The reduction of the lipophilic phosphorus within the overall phosphorus content can help allow the feed to be within a pre-selected phosphorus content range (e.g. less than 2 wppm lipophilic phosphorus, between less than 2 wppm lipophilic phosphorus and 0.1 wppm lipophilic phosphorus, between 1.5 wppm lipophilic phosphorus and 0.1 wppm lipophilic phosphorus, etc.). Further, a suitable pretreatment scheme that can help provide the desired phosphorus content for the feed can be selected to provide a desired lipophilic phosphorus content within a feed in a more efficient manner so that feed within the pre-selected lipophilic phosphorus content threshold can be more routinely provided for hydrotreatment. This can help avoid (or at least reduce) catalyst deactivation and extend the life of the hydrotreatment catalyst.

### Example 3: Removal of P Model Compounds with Various Degree of Lipophilicity

Four commercially available P compounds with different lipophilicity were purchased: tri-octyl-phosphine A, tri-octyl-phosphine oxide B, 18:0 lyso phosphoglycerol C and octadecyl-phosphonic acid D, in order to decrease lipophilicity.

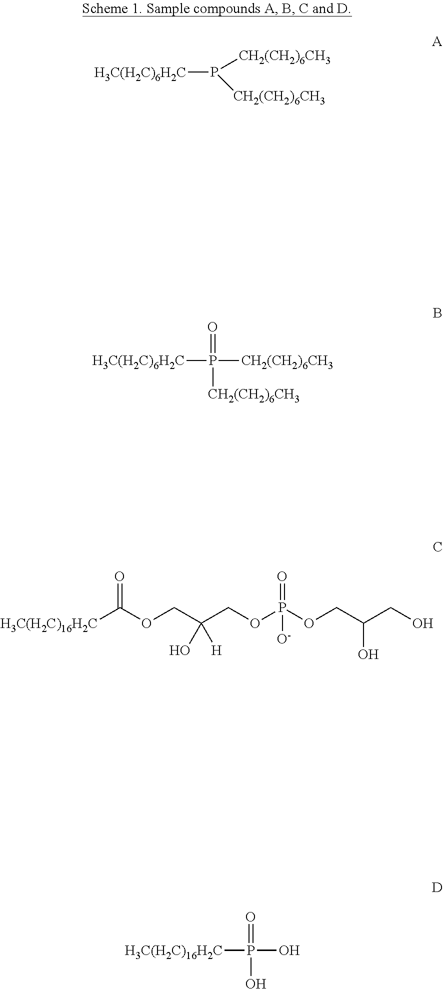

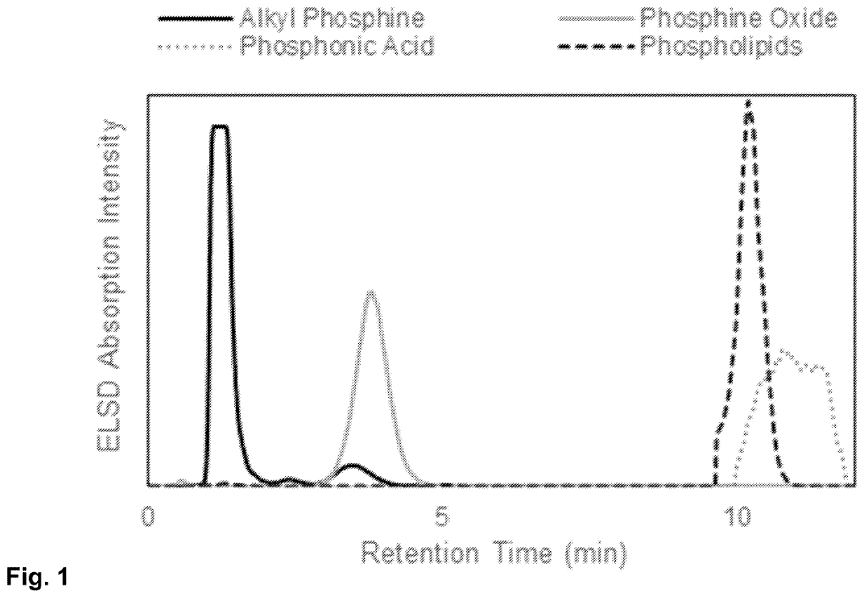

Samples were prepared by spiking a purified vegetable oil with said four (A, B, C, D) model compounds. In SPE separation, the first two compounds were found to elute in the lipophilic fraction, whereas the octadecyl-phosphonic acid and the 18:0 lyso phosphoglycerol eluted later in the amphiphilic fractions. FIG. 1 shows separation into lipophilic P phase (A and B) and amphiphilic P phase (C and D) of the model compounds in the present SPE method. Hence, the results verified the separation efficiency for lipophilic P of the SPE method.

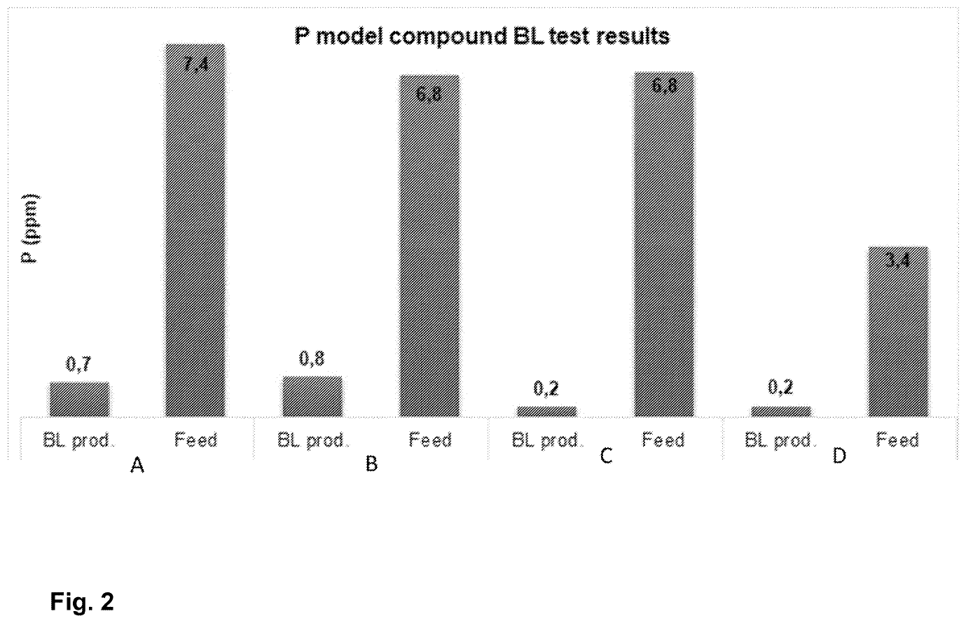

The results were connected to purification of lipid oils by pretreatments. Samples containing the respective model compound were prepared to correspond to elemental phosphorus concentration ~7 wppm. Samples were then bleached (2.5 wt-% dosage of acidic mineral adsorbent). For the two lipophilic compounds (the phosphine and the phosphine oxide), the model solution P concentration after bleaching was reduced to 0.8 wppm again corresponding to elemental phosphorus. For the amphiphilic P compounds, the P content in the bleaching product was 0.2 wppm, demonstrating how amphiphilic impurities are easier removed from lipid matrices by surface chemistry reactions than lipophilic impurities. Lipophilic (A and B) and amphiphilic (C and D) model compound bleaching results are also given in FIG. 2.

In this example the concentration of P compounds was modest and the adsorbent dosage high, which explains the relatively good purification of the lipophilic P. As seen in the example, bleaching (including adsorption as key phenomena) can remove moderate amounts of lipophilic P, but at excessively high adsorbent cost.

### Example 4: Choice of Suitable Pretreatment to Minimize Lipophilic Phosphorus in Animal Fat Samples

Three samples of filtered animal fat were bleached and the residual P (total phosphorus) in the bleaching product was analysed (results in Table 3). Performing a heat treatment of the animal fat effectively mitigated the impact of lipophilic phosphorus compounds therein, in that the heat-treated animal fat could be bleached to low residual P concentration, tentatively due to the heat degradation of both phospholipids or their lipophilic derivatives. The example demonstrated how following the lipophilic phosphorus concentration in feed samples may be used to choose effective pretreatment methods.

The heat treatment (HT) was performed by heating 600 g of the feed in a 1 L stirred autoclave reactor from Parr Instruments, under stirring of 500 rpm. The feed was heated to 280° C. (balance pressure) and kept at 280° C. for 30 min before cooling to about 60° C. In this laboratory experiment, the heating time was 30 min and the cooling time 20 min, with a reaction time of 30 min after heating and before cooling. The treatment severity corresponded roughly to 45 min treatment at 280° C. in a tube reactor setup. The heat-treated product was bleached. The citric acid (2000 mg/kg of sample) was added at 85° C. followed by mixing, 1 wt-% of bleaching earth was added, mixed, and the sample was dried with vacuum and filtered at 105° C. The conditions were the same in all bleaching tests.

TABLE 3
Residual P concentration (wppm) in bleached
samples. Bleaching of samples was done with
1 wt-% dosage of acidic mineral adsorbent.

| | Filtered and | |
|---|---|---|
| | bleached | Heat treated |
| Sample | feed | and bleached |
| Animal fat 1 | 8.4 | 1.7 |
| Animal fat 2 | 16.8 | 0.7 |
| Animal fat 3 | 23.5 | 1.3 |

The results of Example 4 shown in Table 3 indicate that filtering and bleaching did not remove the P (total) to a satisfying purity, and the residual phosphorus is expected to comprise lipophilic phosphorus compounds that are the difficult to remove phosphorus. We believe this is the case because, as previously discussed above, the lipophilic P is not well removed by degumming or bleaching, which are dependent on the amphiphilic character of phosphorus impurities to be removed. Also, example 2 shows that on general, the lipophilic P forms a high portion of the total P in bleaching products (due to its low removal rate in bleaching, compared to the other P impurities), and that on general, the lipophilic P is lower portion of the total P in untreated feeds.

The results shown in Table 3 above show that the use of heat treatment with bleaching as a combination of pretreatments on the sampled feeds was able to effectively remove the lipophilic phosphorus as well as have the overall phosphorus removed to a preferred concentration level. In contrast, filtering and bleaching was unable to provide such effective removal of phosphorus. As discussed above, we believe this is due to the high lipophilic phosphorus content within those samples.

Heat treatment in combination with bleaching was able to provide a reduction in phosphorus that was 78.8% higher in the removal of phosphorus as compared to the filtering and bleaching for the Animal fat 1 sample. For the Animal fat 2 sample, heat treatment in combination with bleaching was able to provide a reduction in phosphorus that was 95.8% higher in the removal of phosphorus as compared to the filtering and bleaching. For the Animal fat 3 sample, heat treatment in combination with bleaching was able to provide a reduction in phosphorus that was 95.5% higher in the removal of phosphorus as compared to the filtering and bleaching

Combination of heat treatment and bleaching yields an excellent purification result, showing that analysing lipophilic phosphorus provides relevant information for the selection of pretreatment for a lipid feed.

### Example 5: Solid Phase Extraction (SPE) Details

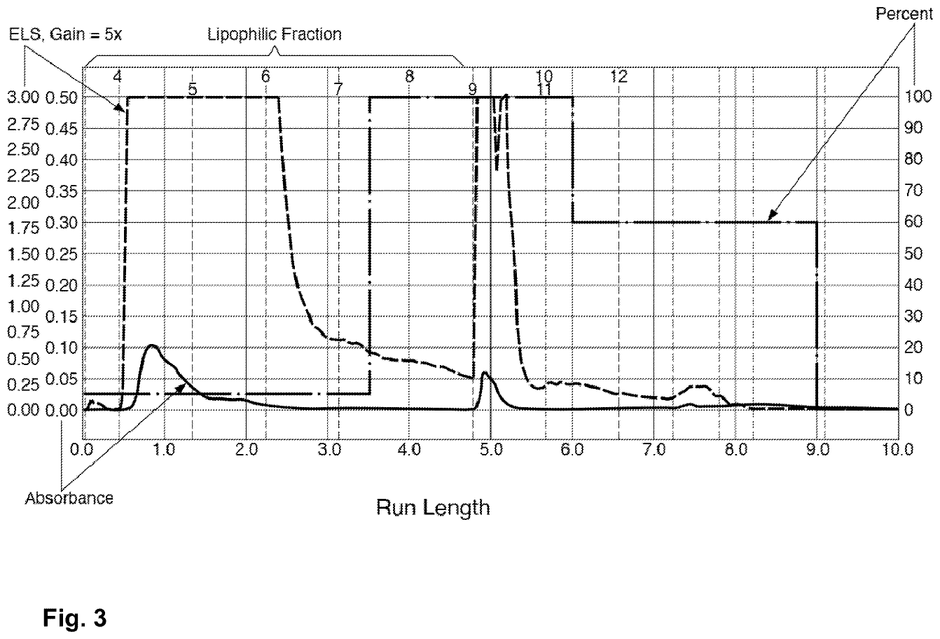

Solid phase extraction (SPE) method was developed for the lipophilic phosphorus analysis. An example chromatogram is given as FIG. 3.

Sample preparation. Samples were melted in a 60° C. oven for 10-15 min. 2.00±0.10 g of sample was transferred with glass pipette into a 20 mL vial and mixed with 2 mL of n-heptane to dissolve the sample. Sample vial was placed in a warm water bath at 50° C. for 2-3 min and shaked well prior to the injection to the SPE column.

Solvents. Analytical grade n-heptane, iso-propanol, and methanol from VWR were used in all analyses as received. SPE parameters. The instrument used was CombiFlash NextGen 300+ equipped with a single use 24 g silica gold column from Teledyne. The method settings used were, liquid sample loading type, solvent flow rate of 45 mL/min, evaporative light scattering detector, UV detector wavelength 1-275 nm, UV detector wavelength 2-385 nm. Solvent gradients were indicated in chromatogram with 0-3.5 min (95% n-Heptane, 5% iso-propanol), 3.5-6 min (100% iso-propanol), 6-9 min (60% methanol, 40% iso-propanol), 9-10 min (100% n-Heptane). The lipophilic (0-4.7 min, tube 1-8) and amphiphilic (4.7-12 min, tube 9+) fractions were collected in pre-weighted 500 mL round bottom flasks, and the solvents were evaporated using a rotary evaporation system according to the system manual. Lipophilic and amphiphilic fractions were weighted after the removal of solvents, and the total P content in lipophilic fractions were measured by an ICP-MS/MS method.

The foregoing description has provided by way of non-limiting examples of particular implementations and embodiments a full and informative description of the best mode presently contemplated by the inventors for carrying out the invention. It is however clear to a person skilled in the art that the invention is not restricted to details of the embodiments presented in the foregoing, but that it can be implemented in other embodiments using equivalent means or in different combinations of embodiments without deviating from the characteristics of the invention.

Furthermore, some of the features of the afore-disclosed example embodiments may be used to advantage without the corresponding use of other features. As such, the foregoing description shall be considered as merely illustrative of the principles of the present invention, and not in limitation thereof. Hence, the scope of the invention is only restricted by the appended patent claims.

1.-20. (canceled)

21. A process for producing renewable hydrocarbons suitable for use in fuel applications from a renewable feedstock containing at least one or more lipophilic phosphorus compound(s), said process comprising:
(i) providing the renewable feedstock, wherein a sum amount of the lipophilic phosphorus compound(s) calculated as elemental phosphorus is more than 2 wppm, of a total feedstock weight;
(ii) subjecting the renewable feedstock to at least one pretreatment to obtain a pretreated renewable feedstock, wherein a sum amount of the lipophilic phosphorus compound(s) calculated as elemental phosphorus in the pretreated renewable feedstock is lower than that of the renewable feedstock in step (i), and/or less than 2 wppm, and/or less than 1.5 ppm, of the pretreated feedstock weight; and
(iii) subjecting the pretreated renewable feedstock to at least one catalytic hydrotreating step to obtain the renewable hydrocarbons.

22. The process of claim 21, wherein two or more feedstock pretreatments are conducted in sequence in step (ii).

23. The process of claim 21, wherein the pretreatment is selected from at least one or more of degumming, heat treatment, heat treatment with adsorbent, acid treatment, filtration, bleaching, blending and/or any combination thereof.

24. The process of claim 22, wherein the combination of pretreatments consists of a combination of blending and heat treatment in said sequence.

25. The process of claim 21, wherein at least one pretreatment step is selected based on data on pretreatments' capability on reducing a sum amount of the lipophilic phosphorus compound(s) in a feedstock; and
subjecting the renewable feedstock to at least one pretreatment thereby selected.

26. The process of claim 21, comprising:
the pretreated renewable feedstock to hydrotreating in a presence of a catalyst selected from at least one or more of Pd, Pt, Ni, Co, Mo, Ru, Rh, W, and/or any combination of these, and/or CoMo, NiMo, NIW, CoNiMo, NiMoW and/or together with SAPO-11, SAPO-41, ZSM-22, ZSM-23, ZSM-12, ZSM-48, ZSM-5, beta zeolites, ferrierite and mixtures thereof, and/or Pt/SAPO-11/Al₂O₃, Pt/ZSM-22/Al₂O₃, Pt/ZSM-23/Al₂O₃, Pt/SAPO-11/SiO₂, and/or on a support, wherein the support is alumina and/or silica, and recovering the obtained liquid product including renewable hydrocarbons.

27. The process of claim 21, wherein the catalytic hydrotreating comprises:
one or more of hydrodeoxygenation, hydroisomerisation and/or hydrocracking.

28. The process of claim 21, wherein the renewable hydrocarbons suitable for use in fuel applications comprise:
components for renewable diesel, sustainable aviation fuel, renewable gasoline or any combination thereof, and/or at least one or more of renewable diesel component meeting requirements for EN15490-2018, sustainable aviation fuel component meeting requirements for ASTM D7566-2020 Annex 2, and/or renewable gasoline component suitable for fuel applications where the fuel meets the requirements for SFS EN 228-2012.

29. The process of claim 21, wherein the renewable feedstock comprises at least one or more of acidulated soapstock, (ASK), poultry fat, dry rendered poultry fat (AFP), brown grease (BG), used cooking oil (UCO), tall oil, fraction of tall oil, crude tall oil (CTO), tall oil pitch (TOP), palm oil mill effluent (POME), crude palm oil (CPO), palm oil, palm seed oil, palm fatty acid distillate (PFAD), babassu oil, carinata oil, coconut butter, muscat butter oil, sesame oil, maize oil, poppy seed oil, cottonseed oil, soy oil, laurel seed oil, jatropha oil, palm kernel oil, camelina oil, archaeal oil, bacterial oil, fungal oil, protozoal oil, algal oil, seaweed oil, mustard seed oil, oils from halophiles, soybean oil (SBO), technical corn oil, rapeseed oil (RSO), colza oil, canola oil, sunflower oil, hemp seed oil, olive oil, linseed oil, mustard oil, peanut oil, castor oil, coconut oil, lard, tallow, train oil, spent bleaching earth oil (SBEO), lignocellulosic based feeds, and/or any mixture thereof.

30. The process of claim 21, comprising:
determining the sum amount of the lipophilic phosphorus compound(s) by an analysis which includes:
separating from the feedstock or said pretreated feedstock at least one fraction containing the lipophilic phosphorus compound(s); and
analysing said fraction to provide data on the at least one lipophilic phosphorus compound.

31. The process of claim 30, wherein said separating comprises:
solid phase extraction (SPE) or flash chromatography, and/or SPE.

32. The process of claim 31, wherein the SPE comprises:
extracting with a solvent system, wherein the solid phase extraction is made with a set of solvents with increasing polarity of solvents in the solvent system.

33. A method of a separation and analysis in catalytic production of renewable hydrocarbons to provide data on at least one lipophilic phosphorus compound(s) in a renewable feedstock, the method comprising:
selecting, based on said separation and analysis, a pretreatment capable of reducing the lipophilic phosphorus compound(s) content; and
subjecting the renewable feedstock to the selected pretreatment to provide a pretreated renewable feedstock.

34. The method according to claim 33, wherein a sum amount of the lipophilic phosphorus compound(s) calculated as elemental phosphorus in the pretreated renewable feedstock is lower than that in the renewable feedstock, and/or less than 2 wppm, and/or less than 1.5 wppm, of the pretreated renewable feedstock weight.

35. The method according to claim 33, wherein the separation and an analysis comprises:
(a) collecting at least one sample of said renewable feedstock;
(b) separating from said sample at least one fraction containing the lipophilic phosphorus compound(s); and
(c) analysing said fraction to provide data on the sum amount lipophilic phosphorus compound in said renewable feedstock.

36. The method according to claim 33, wherein said separating in step (ii) comprises solid phase extraction (SPE) or flash chromatography, and/or SPE.

37. The method according to claim 33, wherein two or more pretreatments are conducted in sequence.

38. The method according to claim 33, wherein the pretreatment is, or the pretreatments are, selected from at least one or more of degumming, heat treatment, heat treatment with adsorbent (HTA), acid treatment, filtration, bleaching, blending and/or any combination thereof.

39. The method according to claim 33, comprising:
subjecting the pretreated renewable feedstock to at least one catalytic hydrotreating to obtain renewable hydrocarbons.

40. The method according to claim 33, comprising:
performing the separation and analysis for reducing a loss of hydrotreatment catalyst activity.
